(19) United States
(12) Patent Application Publication
(10) Pub. No.: US 2024/0387860 A1
(43) Pub. Date: Nov. 21, 2024

(54) METHOD AND DEVICE FOR PRODUCING AN ELECTRODE-SEPARATOR ASSEMBLY FOR A BATTERY CELL

(71) Applicant: TECHNISCHE UNIVERSITÄT BERLIN, Berlin (DE)

(72) Inventors: Alexander MÜLLER, Berlin (DE); Muhammed AYDEMIR, Berlin (DE); Moritz KAHL, Berlin (DE); Franz DIETRICH, Berlin (DE)

(73) Assignee: TECHNISCHE UNIVERSITÄT BERLIN, Berlin (DE)

(21) Appl. No.: 18/692,457

(22) PCT Filed: Sep. 9, 2022
(86) PCT No.: PCT/EP2022/075137

§ 371 Date: Mar. 15, 2024

(30) Foreign Application Priority Data
Sep. 17, 2021 (EP) 21197510.7

(51) Int. Cl. H01M 10/04; H01M 50/403; H01M 50/46

(52) U.S. Cl. CPC H01M 10/0468; H01M 50/403; H01M 50/461

(57) ABSTRACT

The invention relates to a method and a device for producing an electrode-separator assembly for a battery cell. The method comprises the following: supplying a separator material (2) by means of a separator supply device; supplying an electrode (9; 10) by means of an electrode supply device; and producing an electrode-separator assembly by means of a joining device, the electrode (9; 10) being joined to the separator material (2) and an adhesive bond being formed between the electrode (9; 10) and the separator material (2). The electrode (9; 10) and the separator material (2) are joined using at least one vacuum roller (5; 6) which is designed, by means of a roller suction device in a first surface region of a roller body of the vacuum roller (5: 6), to hold the electrode (9; 10) on the roller body at least for supply and, by means of a roller nozzle device in a second surface region of the roller body which is different from the first surface region, to push the electrode away from the vacuum roller (5: 6) towards the separator material (2) for joining, the separator material being supported for joining by a support device which is arranged opposite the vacuum roller (5; 6).

### BACKGROUND

Electrochemical storages such as battery cells consist of an assembly with positive and negative electrodes which are physically separated by a separator. The smallest functional unit of a battery cell (galvanic cell) consists of a positive and a negative electrode with a separator layer in between. Often, multiple galvanic cells are connected in series in the energy storage system with the aim of increasing capacity. To ensure that this series connection does not undergo a reaction with the housing, the assembly always begins with a separator layer and also ends with a separator layer.

Different production methods are used to produce an electrode-separator assembly (ESA), depending on the desired design of the battery cell. In the prior art, a distinction is made between four ESA constructions in particular: The round-wound and the prismatic-wound assembly construction, the stacked construction and the z-folded composite construction. In wound constructions, the electrodes and separators are in the form of a strip and are wound together. In the stacked construction, the battery materials are present as discrete individual sheets and are stacked on top of each other using pick-and-place movements. In the z-folded design, the separator is usually in the form of a strip and is folded in a meandering pattern. Discrete electrodes are inserted into the folded pockets by pick-and-place movements, as in the stacked construction.

Stack formation is the speed-determining process section in the production of high-capacity cells with stacked or z-folded ESA and thus limits the throughput in the production of battery cells. An increase in throughput by increasing the speed or parallelization of existing methods for ESA production shows a throughput limitation that can hardly be overcome due to necessary downtimes in the process sequence. Downtimes in the process sequence are necessary in order to achieve a high level of accuracy in the pick-and-place applications used for joining electrodes and separators. The fact that the resetting movement in pick-and-place requires non-value-adding assembly time and downtimes in the process sequence are necessary for joining the electrodes with the separator is motivating industry and science to search for alternative, high-throughput approaches to stack formation.

In this field of innovation, hot lamination of electrodes and separators is attracting increasing attention. On the one hand, the electrode-separator laminates produced in this manner as an intermediate product allow a higher pick-and-place speed due to their higher handling strength, and on the other hand, the pre-assembly results in a parallelization of the ESA production process, which achieves a multiplication effect in the throughput increase. For lamination, the auxiliary joining material required for the joining process is already present in one of the two joining partners (electrode or separator). The adhesive is heated so that both objects can be joined together. Either a preheating section or a heated pair of rollers is used for heating. Accordingly, the adhesive contained in the joining partners is heated in advance or while the joining partners are pressed together by the pair of rollers and the electrode-separator laminate is produced. This laminate is then supplied as an intermediate product to the stacking or z-folding ESA production process.

Various embodiments in terms of the number and arrangement of the layers are known for electrode-separator laminates as an intermediate product for subsequent series connection.

For example, embodiments are provided which, as a half cell, represent a separator with an electrode and, in some cases, with a further separator. Furthermore, the term mono-cell is understood to mean an assembly consisting of a positive and negative electrode with a separator layer in between. A bi-cell, on the other hand, is understood to be an assembly in the order positive electrode, separator, negative electrode and separator or negative electrode, separator, positive electrode and separator. Furthermore, the materials can be present in a continuous manner, i.e., in the form of strip material or cut to size as sheets. In the case of strip-shaped electrodes, these can be coated continuously or intermittently.

The document EP 2 757 625 B1 describes a method for the step-by-step multiple lamination of a bi-cell to form a stackable intermediate product.

Document DE 10 2018 219 000 A1 discloses a method for producing a half-cell by means of lamination, wherein a vacuum belt or a laminating device is used as the handling device.

Document DE 601 04 890 T2 describes a method for the hot lamination of anode and cathode using a rotary converting lamination machine.

Document EP 2 830 139 A1 discloses a device for laminating anodes and cathodes, which can also discretize.

Document DE 10 2014 113 588 A1 describes a method for producing electrode-separator laminates consisting of two strip-shaped separators and an electrode sheet therebetween. A join connection between the first strip-shaped separator and the electrode sheet is implemented by applying an adhesive. The adhesive is applied to the separator web. A join connection between the two strip-shaped separators is carried out by laser welding. The strip-shaped separators and the electrode sheets are handled by means a vacuum belt which, due to the porosity of the separator, can also exert a tensile load through the separator and thus exert a force on the electrode placed thereon. By subsequently separating the separator band, one or more discrete half cells are formed.

Document WO 2008/080507 A1 describes a method for producing a half cell with an electrode adhesively bonded to the separator. The separator is activated with a chemical primer prior to adhesive bonding. During or after adhesive bonding, the layered assembly is pressed together.

The document DE 10 2010 055 053 A1 describes a method and a system for structuring sheet-shaped electrodes. In order to structure both opposing surfaces of an electrode sheet, the electrode sheet is transported in stages over several vacuum belts. The vacuum belts are arranged in such a manner that both surfaces are successively accessible for structuring.

Document EP 2 641 286 B1 discloses a method and a device for cleaning electrodes or separators, wherein the handling thereof takes place between the cleaning devices via (vacuum) conveyor belts.

Document DE 10 2017 216 213 A1 discloses a method for producing an electrode stack in which a vacuum wheel is used to cut electrodes to size and place them on a vacuum workpiece carrier.

In order to comply with permitted temperature gradients and the minimum melting and contact dwell time during production, increasingly longer preheating sections are required. The resulting increase in space requirements for the systems leads to economic restrictions with regard to the drying room to be operated. Furthermore, laminating restricts the material selection: The separator or electrodes must carry fusible components and be able to withstand high temperatures and gradients; all materials must be prepared for the adhesion-promoting pressure load. Nowadays, automotive and cell manufacturers tolerate this restriction in favor of the higher throughput compared to conventional stacking or z-folding.

### SUMMARY

The object of the invention is to provide a method and a device for producing an electrode-separator assembly for a battery cell, which support efficient and time-saving production of the electrode-separator assembly.

In order to achieve this object, a method and a device for producing an electrode-separator assembly for a battery cell according to the independent claims 1 and 13 are provided. Configurations are the subject matter of dependent subclaims.

According to one aspect, a method for producing an electrode-separator assembly for a battery cell is provided, which comprises the following: supplying a separator material by means of a separator supply device; supplying an electrode by means of an electrode supply device; producing an electrode-separator assembly by means of a joining device, the electrode being joined to the separator material and an adhesive bond being formed between the electrode and the separator material. The electrode and the separator material are joined using at least one vacuum roller which is designed, by means of a roller suction device in a first surface region of a roller body of the vacuum roller, to hold the electrode on the roller body at least for supply and, by means of a roller nozzle device in a second surface region of the roller body which is different from the first surface region, to push the electrode away from the vacuum roller towards the separator material for joining, the separator material being supported for joining by a support device which is arranged opposite the vacuum roller.

According to another aspect, a device for producing an electrode-separator assembly for a battery cell is provided, comprising the following: a separator supply device which is designed to supply a separator material; an electrode supply device which is designed to supply an electrode; a joining device which is designed to produce an electrode-separator assembly, the electrode being joined to the separator material and an adhesive bond being formed between the electrode and the separator material; at least one vacuum roller; and a support device which is arranged opposite the vacuum roller. The vacuum roller is designed, by means of a roller suction device in a first surface region of a roller body of the vacuum roller, to hold the electrode on the roller body at least for supply and, by means of a roller nozzle device in a second surface region of the roller body which is different from the first surface region, to push the electrode away from the vacuum roller towards the separator material for joining.

With the help of the proposed technology, it is possible to produce the electrode-separator assembly in large quantities with high accuracy and in a time-saving manner. The configuration and operation of the vacuum roller support the precise joining of separator material and electrode. The different surface regions on the roller body formed by the roller suction device and roller nozzle device allow the electrode to be sufficiently held on the surface of the roller body for transport and supply on the one hand and a precise detachment of the electrode from the roller body towards the separator material during joining on the other. The design of the vacuum roller with the different surface regions also supports the handling of electrodes of different sizes depending on the application.

Before joining, a bonding agent can be applied to the electrode and/or the separator material in a first surface region, and the electrode can be pushed away from the vacuum roller towards the separator material by means of the roller nozzle device during joining to form an adhesive bond between the electrode and the separator material in the first surface region or in a region opposite the first surface region on the separator material. In this manner, the joining of the material of the electrode and the separator material takes place specifically and (first) preferably in the regions to which the bonding agent was previously applied, be it on the electrode and/or the separator material. In this manner, it is made possible to selectively join the surface regions provided with adhesive at the shortest possible time interval from the application of the adhesive. It can be provided that surface regions spaced apart and separated from each other, which are each provided with adhesive, are detached from the vacuum roller by means of associated nozzles of the roller nozzle device and moved and pushed towards the separator material for joining. In this manner, the electrode can selectively be joined to the separator material first in the surface regions provided with the adhesive (contact regions), in order to then, at a time interval therefrom, also join surface regions not initially provided with adhesive. In this manner, it is possible in particular to prevent kinks or folds from forming on the separator material, which can at least hinder the correct production of the electrode-separator assembly.

A second electrode surface region, which is different from the first electrode surface region, can remain free of adhesive, and the second electrode surface region can be free of pressurization by the roller nozzle device during joining.

The adhesive bond can be formed by means of an adhesive bonding process free of heat supply. Forming the adhesive bond in an adhesive bonding process free from heat supply preferably comprises forming the adhesive bond at room temperature, so that the adhesive used as the bonding agent cures at room temperature. Such adhesives are known as such in various embodiments.

During joining, the electrode can be pushed against the separator material by means of mechanical pressurization by the roller body of the vacuum roller. The mechanical pressurization can be superimposed with a pneumatic pressure, which is applied by means of the roller nozzle device during joining.

The roller suction device in the first surface region and the roller nozzle device in the second surface region of the roller body can be controlled independently of each other when supplying and joining in order to hold the electrode on the roller body in certain regions and push it towards the separator material. Controlling the roller nozzle device and the roller suction device independently of each other makes it possible to control and to apply the suction effect on the one hand and the repulsion effect on the other separately from each other. In this or other configurations, partial surface regions can be formed within the first and/or second surface region, for which the roller suction device or the roller nozzle device can in turn be controlled separately in order to individually adjust the suction/repulsion effect in the separate partial surface regions. For this purpose, the surface regions or the partial surface regions are assigned respective pressure devices for forming negative pressure/positive pressure, which can be arranged at least partially in an interior of the roller body, for example corresponding supply lines.

The roller nozzle device can be formed in the second surface region in relation to the roller suction device in a first surface region of the roller body according to at least one of the following arrangements: laterally adjacent and between multiple second surface regions. The lateral adjacency can be formed in the axial direction and/or along a curved mantle (radial).

A vacuum roller with at least one of the following configurations can be used: Roller suction device with punctiform suction openings in the first surface region and roller nozzle device with slotted-hole nozzles in the second surface region. In this or other configurations, the roller suction device and the roller nozzle device can be formed to be continuous or discontinuous along the circumferentially extending surface of the roller body. In one configuration, only a partial region of the surface of the roller body can be covered by this.

During supply, the electrode can be deflected by the vacuum roller from a first transport direction into a second transport direction, which runs transverse to the first transport direction and in which the joining is carried out. For example, supplying the material for the electrode can be carried out in the first transport direction in a horizontal direction, whereas the joining is carried out on a separator material transported in a vertical direction. Thus, a deflection of approximately 90 degrees takes place.

The support device can be formed with a further vacuum roller, which is designed to be used according to the mode of operation of the vacuum roller to join a further electrode to separator material. In its various configurations, the support device serves to support the separator material on the opposite side to the vacuum roller during joining, so that the contact pressure for the electrode can be provided on the separator material. The further electrode can be joined to the separator material according to the procedure for joining the electrode, or differently.

In one configuration, the vacuum roller is arranged opposite the further vacuum roller and thus forms at least part of the supporting device on one side. In addition, the further vacuum roller can be operated in a manner comparable to the vacuum roller, such that it supplies the further electrode during operation in order to join the electrode to the separator material on the opposite side.

In this or other embodiments, the electrode and the further electrode can be arranged directly opposite one another on the opposite sides of the separator material. Alternatively, it can be provided that the electrode and the further electrode are arranged offset to each other in the longitudinal direction of the separator material on opposite sides of the electrode material. In this manner, different electrode-separator assemblies can be produced. For this purpose, the processes of supplying the electrodes on the opposite sides of the separator material can be timed accordingly in each case.

The separator material can be supplied by means of the separator supply device as a strip material at a strip speed of at least about 500 mm/s. The strip material for the separator material can be supplied from a roll, for example. After the electrode-separator assembly has been joined, it is separated from the strip material by means of a separating device. It can also be provided to deposit the strip material with the multiple electrode-separator assemblies as strip material, for example by means of a z-fold, as described, for example, in document DE 10 2015 108 651 A1. In one configuration, a strip speed of up to about 3000 mm/s is used.

After joining, the electrode-separator assembly can be processed by means of a pressing device downstream of the vacuum roller and the support device. Here, for example, rollers or rolls can be provided to (additionally) press the electrode-separator assembly. Such rolls or rollers can be arranged on opposite sides of the assembly.

In the various configurations, the electrode and/or the further electrode can be supplied and joined as an individual electrode or as an electrode strip.

The configurations explained above in connection with the method for producing an electrode-separator assembly for a battery cell can be provided accordingly in connection with the device for producing the electrode-separator assembly.

### DESCRIPTION OF EXEMPLARY EMBODIMENTS

Further embodiments are explained below with reference to figures in a drawing. In the figures:

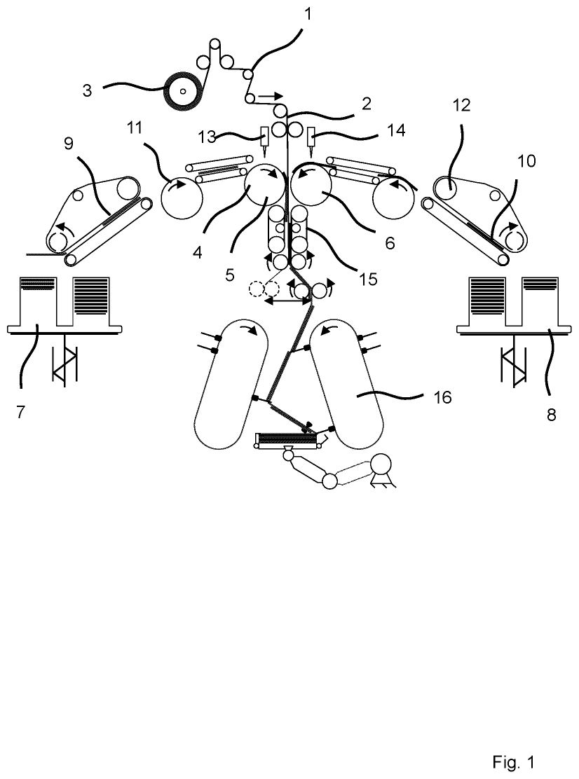

FIG. 1 shows a schematic illustration of an arrangement with a device for producing an electrode-separator assembly for a battery cell;

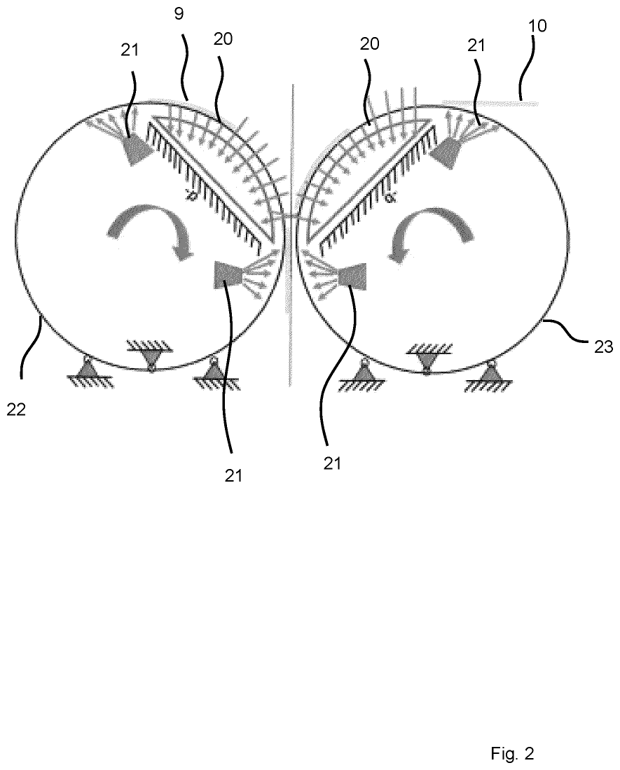

FIG. 2 shows a schematic illustration with two opposing vacuum rollers, each having a roller suction device and a roller nozzle device;

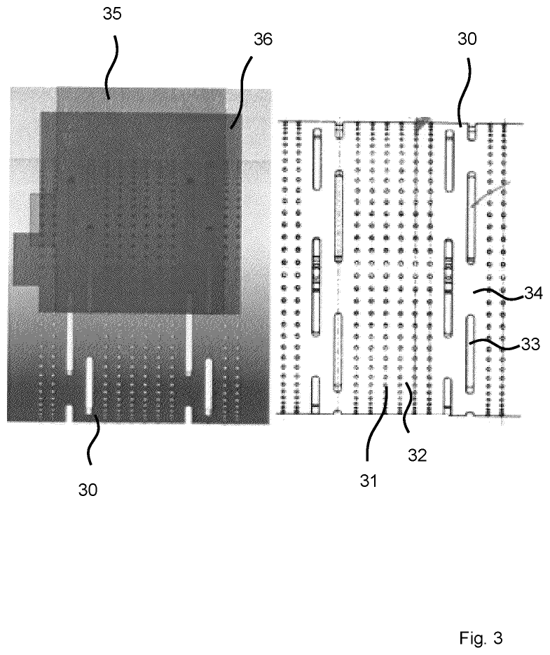

FIG. 3 shows a schematic illustration of a surface section of a roller body of a vacuum roller;

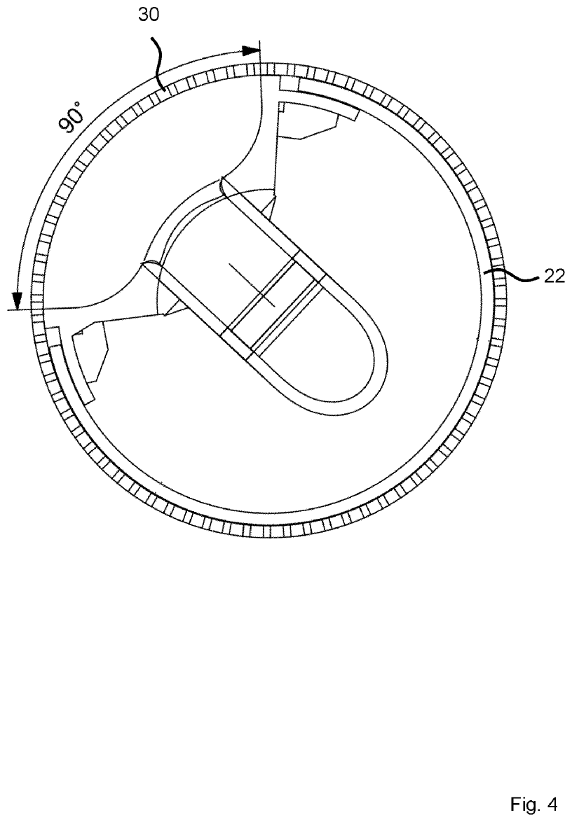

FIG. 4 shows a sectional view of a roller body;

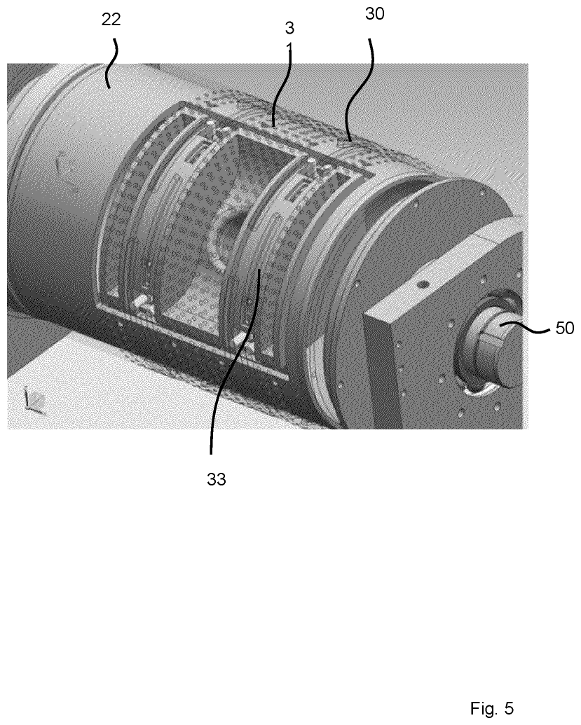

FIG. 5 shows a schematic perspective illustration of a vacuum roller with bearings;

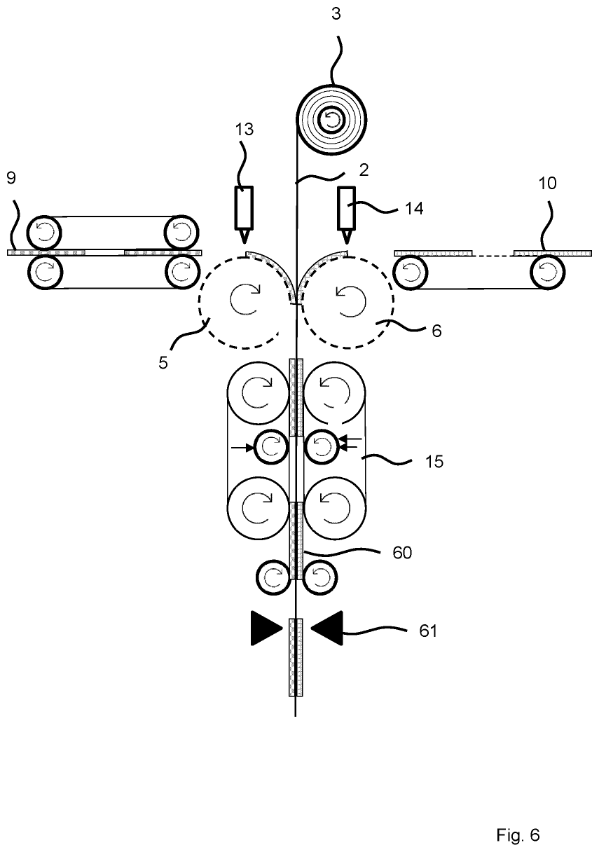

FIG. 6 shows a schematic illustration of a device for producing an electrode-separator assembly in the form of discretized mono-cells;

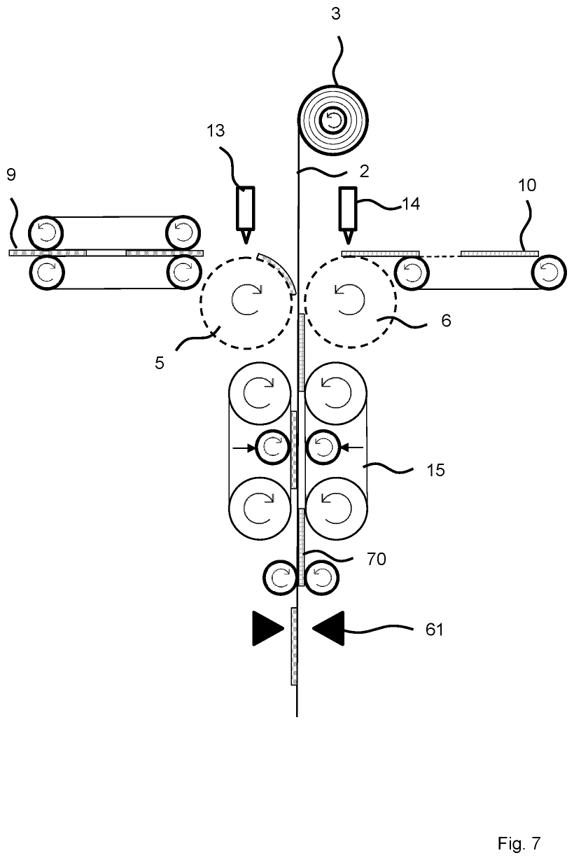

FIG. 7 shows a schematic illustration of a device for producing an electrode-separator assembly in the form of discretized half cells;

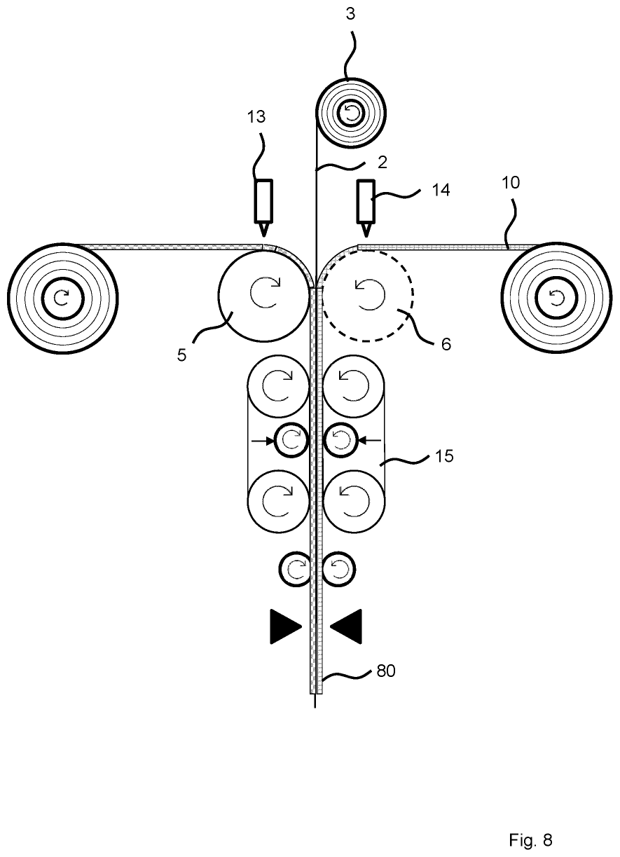

FIG. 8 shows a schematic illustration of a device for producing an electrode-separator assembly in the form of strip-shaped mono-cells;

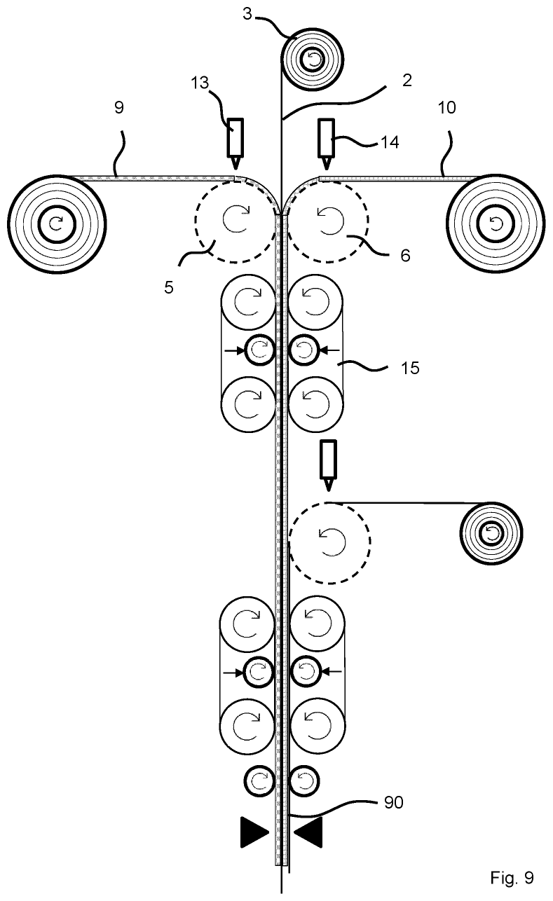

FIG. 9 shows a schematic perspective illustration of a further device for producing an electrode-separator assembly in the form of a strip-shaped mono-cell;

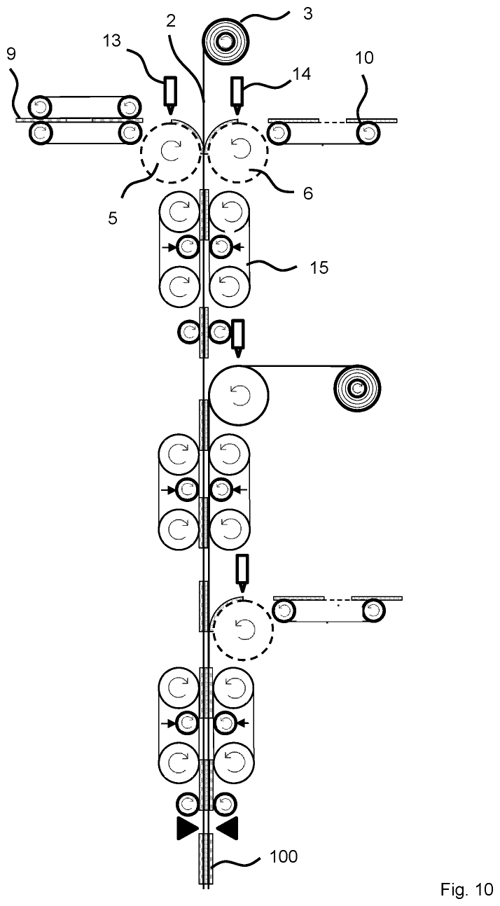

FIG. 10 shows a schematic illustration of a device for producing an electrode-separator assembly in the form of a discretized mono-cell; and

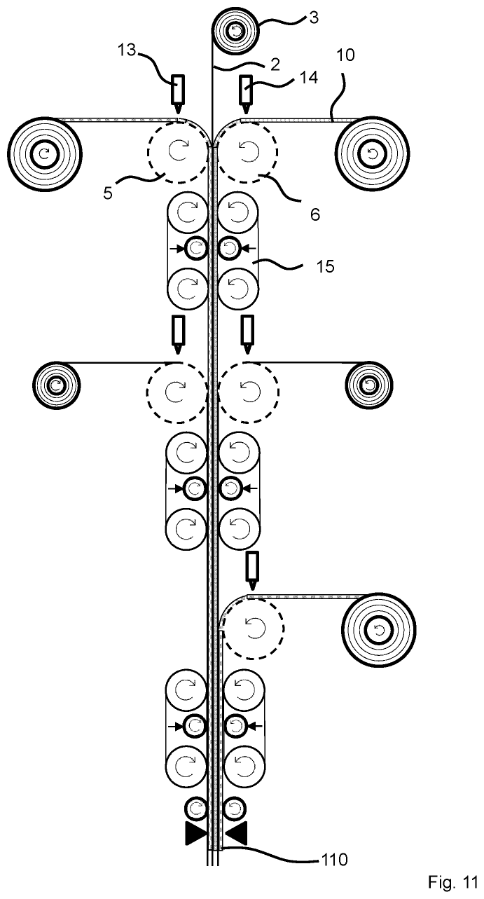

FIG. 11 shows a schematic perspective illustration of a further device for producing an electrode-separator assembly in the form of a strip-shaped mono-cell.

FIG. 1 shows a schematic illustration of an arrangement with a device for producing an electrode-separator assembly for a battery cell. With the help of a separator supply device 1, a separator material 2, which is formed here as a strip material, is supplied from a roll 3 in the vertical transport direction to a joining device 4. A first and a second vacuum roller 5, 6 are arranged opposite each other on opposite sides of the separator material 2. From a first and a second reservoir 7, 8 for a first and a second electrode 9, 10, the electrodes are supplied to the two vacuum rollers 5, 6 by means of a first and a second supply device 11, 12 and then transported with these to the joining device 4. On this path, the first and second electrodes 9, 10 are each provided with an adhesive by means of a bonding agent dispenser 13, 14, in order to then join the first and second electrodes 9, 10 on opposite sides to the separator material 2 with the aid of the adhesive in the joining device 4. In the embodiment shown, the first and second electrodes 9, 10 are joined on opposite sides of the separator material 2 in staggered sections.

With the help of a pressing device 15, the assembly with electrodes 5, 6 and separator material 2 is optionally additionally pressed together. A folding device 16 is used to fold the strip material of the separator material 2 with the first and second electrodes 5, 6 joined thereto (Z-folding).

FIG. 2 shows a schematic illustration with the two opposing vacuum rollers 5, 6, each having a roller suction device 20 and a roller nozzle device 21, which provide a suction pressure in separate surface regions of a respective roller body 22, 23 for the first and second electrodes 9, 10 to hold them on the respective roller body 22, 23 and an overpressure to detach the electrode from the roller body 22, 23 and push it locally against the separator material 2 during joining.

FIG. 3 shows a schematic illustration of a surface section 30 of one of the roller bodies 22, 23 with punctiform suction openings 31 in a first surface region 32 of the roller body and slotted-hole openings 33 in a second surface region 34 of the roller body which is different from the first surface region 32. The punctiform suction openings 31 are assigned to the roller suction device 20. The slotted-hole openings 33 are assigned to the roller nozzle device 21 and are used to eject air.

Electrodes 35, 36 of different sizes can be held in different surface regions and/or within a surface region on the roller body by means of individually activating the punctiform suction openings 31.

FIG. 4 shows a sectional view of one of the roller bodies 22, 23.

FIG. 5 shows a schematic perspective illustration of a vacuum roller with bearing 50.

FIGS. 6 to 11 each show a schematic illustration of different embodiments of an arrangement for a device for producing an electrode-separator assembly in different configurations. The same reference signs as in FIG. 1 are used in FIGS. 6 to 11 for identical features.

The method and the device are used to produce electrode-separator assemblies (ESA) by means of adhesive bonding. The proposed method allows the high-throughput production of ESAs of different embodiments.

As a first example of an embodiment, the production of mono-cells 60 is described in FIG. 6. A strip-shaped separator (1) is unwound to produce the mono-cell 60. Discrete electrodes 9, 10 are transferred from both sides at an angle of less than 180° to the separator material 2, preferably at an angle of 90°, to the vacuum rollers 5, 6 with the aid of the supply devices 11, 12, preferably by a vacuum conveyor belt.

The vacuum rollers 5, 6 are rotating perforated rollers to which negative pressure is applied. A negative-pressure insert statically attached to a hollow shaft inside each perforated roller (roller body) allows sealing to the perforated roller. The negative pressure generates an air flow into the interior of the roller, whereby the electrode 5, 6 is sucked in and moved in a nonpositive manner. The rotational movement of the perforated roller around the hollow shaft allows for a nonpositive deflection of the electrodes 9, 10 from the original supply angle to a parallel alignment to the separator material 2. The vacuum rollers 5, 6 have the same circumferential speed as the translational speed of the separator material 2 (supply speed). The electrodes 9, 10 are held by air nozzles before and after the negative-pressure region to ensure a clean suction and a clean release process, respectively.

In order to fix the electrodes 9, 10 to the separator material 2, an adhesive is applied to one side of the supplied electrodes 9, 10 by means of bonding agent dispensers 13, 14. The adhesive can be applied in the form of dots, lines or over an entire surface, with dot-by-dot application being preferred. Spray, flow nozzle, roller, pour or melt application systems can be used as bonding agent dispensers 13, 14, with spray application systems being preferred. The embodiment according to FIG. 6 shows a flow application system with a dot application system.

On the basis of investigations carried out, the so-called open assembly time of the adhesive joint, i.e., the period of time after the adhesive has been applied until the two joining partners come into contact, mainly influences the stiffness of the join connection. The closed assembly time can be adjusted by positioning the bonding agent dispenser 13, 14, taking into account the feed speed. Positioning closer to the vacuum roller 5, 6 thus results in a shorter closed assembly time compared to positioning further away. Furthermore, the so-called closed assembly time also influences the stiffness of the join connection. The closed assembly time is the period of time in which both joining partners are held together without shear stress. This time can be set using the length of the pressing device 15.

The discrete electrodes 9, 10 are thus joined on the right and left with the strip-shaped separator material 2. The right- and left-side supply of the electrodes 9, 10 by means of the first and second supply devices 11, 12 and the vacuum rollers 5, 6 is synchronized with the separator feed. The centers of gravity of the supplied and joined electrodes 9, 10 overlap in order to obtain a maximum yield of the capacity of the battery cell.

The device is further characterized by the parallel alignment of the two vacuum rollers 5, 6. For example, the distance between the vacuum rollers 5, 6 is exactly the summed thickness of the electrode 9, 10 and the separator material 2.

After the discrete electrodes 9, 10 have been placed onto the strip-shaped separator material 2 by the vacuum rollers 5, 6, the assembly is subjected to a defined pressure by means of the pressing device 15 in order to ensure that the electrodes 9, 10 adhere to the separator material 2. This pressure is generated by two counter-rotating belts between which the assembly runs. Optionally, the pressing can also be carried out by the vacuum rollers 5, 6 if a defined preload is set.

Supplying and joining of the discrete electrodes 9, 10 takes place continuously, wherein a defined distance must be maintained between each of the similar electrodes 9, 10. In the final step, the strip-shaped bonded ESA is cut to size by means of a cutting device 61. Cutting to size is carried out in regions of the separator material 2 that protrude beyond the electrodes 9, 10. Advantageously, cutting to size can be carried out by a roller knife or a laser.

In a final step, the ESAs that are cut to size can be stored or supplied directly into the stacking or z-folding ESA production process by a handling device.

FIG. 7 shows a schematic illustration of a device for producing an electrode-separator assembly in the form of discretized half cells 70. FIG. 8 is a schematic illustration of a device for producing an electrode-separator assembly in the form of strip-shaped mono-cells 80.

FIG. 9 shows a schematic perspective illustration of a further device for producing an electrode-separator assembly in the form of a strip-shaped mono-cell 90. FIG. 10 shows a schematic illustration of a device for producing an electrode-separator assembly in the form of a discretized mono-cell 100, and FIG. 11 shows a schematic perspective illustration of a further device for producing an electrode-separator assembly in the form of a strip-shaped mono-cell 110.

The features disclosed in the above description, the claims and the drawing can be of importance both individually and in any combination for the implementation of the various embodiments.

1. A method for producing an electrode-separator assembly for a battery cell, comprising:
supplying a separator material using a separator supply device;
supplying an electrode using an electrode supply device;
producing an electrode-separator assembly using a joining device, the electrode being joined to the separator material and an adhesive bond being formed between the electrode and the separator material;
wherein the electrode and the separator material are joined using at least one vacuum roller which is configured to hold, by a roller suction device in a first surface region of a roller body of the vacuum roller, the electrode on the roller body at least for supply and, to push, by a roller nozzle device in a second surface region of the roller body which is different from the first surface region, the electrode away from the vacuum roller towards the separator material for joining, the separator material being supported for joining by a support device which is arranged opposite the vacuum roller.

2. The method according to claim 1, characterized in that, before joining, a bonding agent is applied onto the electrode and/or the separator material in a first surface region and the electrode is pushed away, during joining, from the vacuum roller towards the separator material by the roller nozzle device to form an adhesive bond between the electrode and the separator material in the first surface region or in a region opposite the first surface region on the separator material.

3. The method according to claim 2, characterized in that a second electrode surface region, which is different from the first electrode surface region, remains free of bonding agent and the second electrode surface region is free of pressurization by the roller nozzle device during joining.

4. The method according to claim 2, characterized in that the adhesive bond is formed by an adhesive bonding process free of heat supply.

5. The method according to claim 1, characterized in that, during joining, the electrode is pushed against the separator material by mechanical pressurization by the roller body of the vacuum roller.

6. The method according to claim 1, characterized in that the roller suction device in the first surface region and the roller nozzle device in the second surface region of the roller body, during supplying and joining, are controlled independently of each other in order to hold the electrode on the roller body and to push the electrode towards the separator material in sections.

7. The method according to claim 1, characterized in that the roller nozzle device is formed in the second surface region in relation to the roller suction device in a first surface region of the roller body according to at least one of the following arrangements: laterally adjacent and between several second surface regions.

8. The method according to claim 1, characterized in that a vacuum roller having at least one of the following configurations is used:
roller suction device with punctiform suction openings in the first surface region and
roller nozzle device with slotted-hole nozzles in the second surface region.

9. The method according to claim 1, characterized in that the electrode is deflected by the vacuum roller during supply from a first transport direction into a second transport direction which runs transverse to the first transport direction and in which the joining is carried out.

10. The method according to claim 1, characterized in that the supporting device is formed with a further vacuum roller which is configured to be used in accordance with the mode of operation of the vacuum roller to join a further electrode to separator material.

11. The method according to claim 1, characterized in that the separator material is supplied by the separator supply device as a strip material at a strip speed of at least about 500 mm/s.

12. The method according to claim 1, characterized in that the electrode-separator assembly is processed after joining by a pressing device arranged downstream of the vacuum roller and the supporting device.

13. A device for producing an electrode-separator assembly for a battery cell, comprising:
a separator supply device which is configured to supply a separator material;
an electrode supply device which is configured to supply an electrode;
a joining device which is configured to produce an electrode-separator assembly, the electrode being joined to the separator material and an adhesive bond being formed between the electrode and the separator material;
at least one vacuum roller; and
a supporting device which is arranged opposite the vacuum roller;
wherein the vacuum roller is configured to hold, by a roller suction device in a first surface region of a roller body of the vacuum roller, the electrode on the roller body at least during supply and to push, by a roller nozzle device in a second surface region of the roller body which is different from the first surface region, the electrode away from the vacuum roller towards the separator material for joining.
